(19) United States
(12) Patent Application Publication
(10) Pub. No.: US 2024/0155441 A1
(43) Pub. Date: May 9, 2024

(54) CSI-RS INTRA-FREQUENCY AND INTER-FREQUENCY MEASUREMENT

(71) Applicant: QUALCOMM Incorporated, San Diego, CA (US)

(72) Inventors: Tianyang BAI, Mountain View, CA (US); Yan ZHOU, San Diego, CA (US); Junyi LI, Fairless Hills, PA (US); Tao LUO, San Diego, CA (US)

(21) Appl. No.: 18/499,772

(22) Filed: Nov. 1, 2023

Related U.S. Application Data
(60) Provisional application No. 63/382,245, filed on Nov. 3, 2022.

(51) Int. Cl. H04W 36/00; H04B 7/06

(52) U.S. Cl. CPC H04W 36/0058; H04B 7/0626

(57) ABSTRACT

This disclosure provides systems, methods and apparatus, including computer programs encoded on computer storage media for a user equipment (UE) to perform layer 1 (L1) measurements of a candidate cell for an L1/L2 mobility procedure. The UE receives, from a current serving cell, a configuration of a channel state information (CSI) reference signal (RS) measurement resource for L1 measurements of a candidate cell. The UE measures a signal transmitted from the candidate cell based on whether the candidate cell is an intra-frequency candidate cell or an inter-frequency candidate cell. The UE may transmit a CSI report including the L1 measurements of the candidate cells to the current serving cell.

### CROSS-REFERENCE TO RELATED APPLICATIONS

This application claims priority to U.S. Provisional Application No. 63/382,245 titled “CSI-RS INTRA-FREQUENCY AND INTER-FREQUENCY MEASUREMENT,” filed Nov. 3, 2022, which is assigned to the assignee hereof, and incorporated herein by reference in its entirety.

### TECHNICAL FIELD

The present disclosure relates to wireless communications including channel state information (CSI) reference signal (RS) configuration for intra-frequency and inter-frequency measurement.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for performing layer 1 (L1) measurements of a candidate cell. The method includes receiving, from a current serving cell, a configuration of a channel state information (CSI) reference signal (RS) measurement resource for layer 1 (L1) measurements of a candidate cell. The method includes measuring a signal transmitted from the candidate cell based on whether the candidate cell is an intra-frequency candidate cell or an inter-frequency candidate cell.

The present disclosure also provides an apparatus (e.g., a UE) including a memory storing computer-executable instructions and at least one processor configured to execute the computer-executable instructions to perform at least one of the above methods, an apparatus including means for performing at least one of the above methods, and a non-transitory computer-readable medium storing computer-executable instructions for performing at least one of the above methods.

One innovative aspect of the subject matter described in this disclosure can be implemented in a method of configuring a UE to perform L1 measurements. The method includes transmitting, from a current serving cell, a configuration of a channel state information (CSI) reference signal (RS) measurement resource for layer 1 (L1) measurements of a candidate cell, wherein the configuration is based on whether the candidate cell is an intra-frequency candidate cell or an inter-frequency candidate cell. The method includes receiving a L1 CSI report including measurements of the candidate cell.

The present disclosure also provides an apparatus (e.g., a BS) including a memory storing computer-executable instructions and at least one processor configured to execute the computer-executable instructions to perform at least one of the above methods, an apparatus including means for performing at least one of the above methods, and a non-transitory computer-readable medium storing computer-executable instructions for performing at least one of the above methods.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram illustrating an example of a layer 1 or layer 2 (L1/L2) mobility scenario for primary cells (PCells).

FIG. 6 is a diagram illustrating an example of a L1/L2 mobility scenario for secondary cell (SCell) switching.

FIG. 7 is a diagram illustrating an example of a L1/L2 mobility scenario for cell groups (CGs).

FIG. 8 is a diagram illustrating transmission of synchronization signal blocks (SSB) or channel state information (CSI) reference signal (RS) for both intra-frequency and inter-frequency measurement.

FIG. 9 is a diagram illustrating an example of a configuration message for configuring L1 measurements.

FIG. 10 is a message diagram illustrating various messages for performing L1 measurements.

FIG. 11 is a conceptual data flow diagram illustrating the data flow between different means/components in an example network node such as a BS.

FIG. 12 is a conceptual data flow diagram illustrating the data flow between different means/components in an example UE.

FIG. 13 is a flowchart of an example of a method for a UE to perform L1 measurements of a candidate cell.

FIG. 14 is a flowchart of an example method for a network node to configure L1 measurements of a candidate cell.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B. High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Conventionally, in a wireless communications network such as a 5G NR network, mobility procedures are performed at layer 3 (L3) using radio resource control (RRC) messaging. Mobility procedures allow a user equipment (UE) to move from a source cell to a target cell. The mobility procedures may be based on layer 3 measurements of candidate cells. For example, a UE may be configured to measure candidate cells and transmit a measurement report in response to various conditions. In some scenarios, L3 mobility procedures may involve an interruption or gap in communications as the UE establishes an RRC connection with the target cell. Mobility procedures at layer 1 or layer 2 (L1/L2) offer the possibility of improving the speed of mobility over L3 mobility procedures. L1 and L2, however, offer less flexibility in terms of types and content of messages that may be transmitted. Additionally, L1 measurements may require different definitions of intra-frequency and inter-frequency measurements for the UE to be able to correctly configure and perform the L1 measurements.

In an aspect, the present disclosure provides for L1 measurements that may be used in L1/L2 mobility. In contrast to an L3 configuration of measurement objects or a measurement report, the L1 measurements may be configured as channel state information (CSI) reference signal (RS) measurement resources. Although 3GPP TS Release 17 may allow configuration of a CSI-RS measurement resource for an intra-frequency cell, such measurements are too limited for L1/L2 mobility. In an aspect, the UE may receive, from a current serving cell, a configuration of a CSI-RS measurement resource for layer 1 (L1) measurements of a candidate cell. The UE may measure a signal transmitted from the candidate cell based on whether the candidate cell is an intra-frequency candidate cell or an inter-frequency candidate cell. Accordingly, the UE may determine L1 measurements of various types of candidate cells. In some implementations, the UE may initiate an L1/L2 mobility procedure based on the L1 measurements (e.g., satisfying defined conditions). In some implementations, the UE may report the L1 measurements to the current serving cell in a CSI report.

Particular implementations of the subject matter described in this disclosure can be implemented to realize one or more of the following potential advantages. L1/L2 mobility procedures may improve the latency of mobility, thereby reducing interruption in communications during mobility. The use of CSI-RS measurement resources may provide flexibility in configuring measurements of both intra-frequency and inter-frequency candidate cells. L1/L2 mobility may use less signaling overhead than other mobility procedures.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

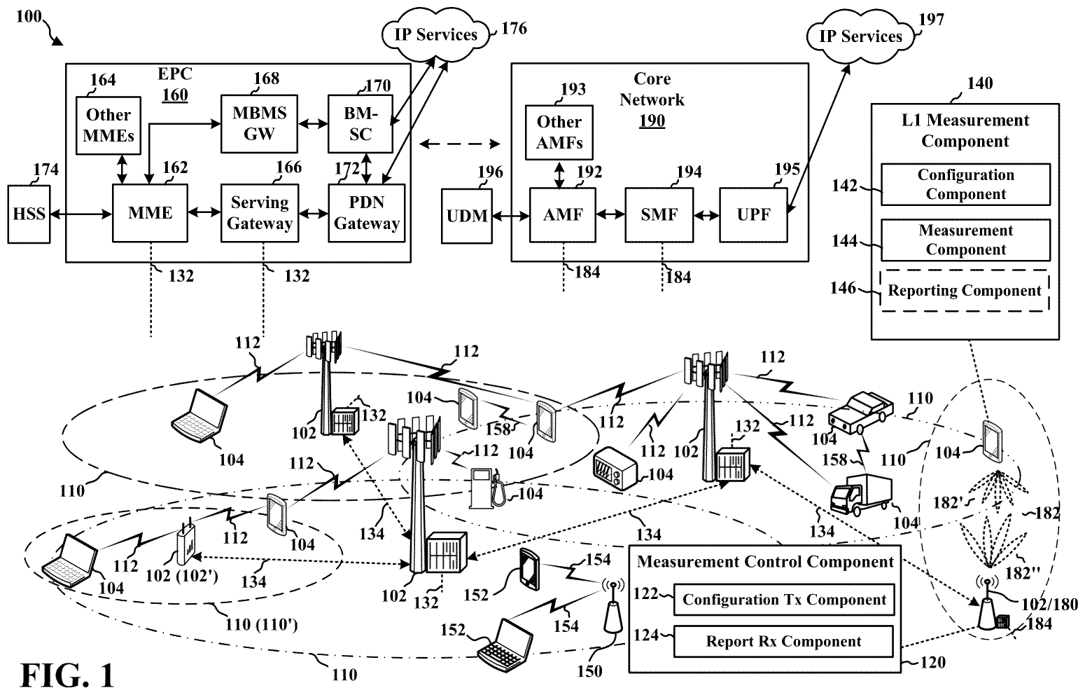

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. A network node may include one or more of a base station 102, a CU, a DU, or an RU.

In some implementations, one or more of the UEs 104 may include a L1 measurement component 140 that measures L1 channel characteristics. The L1 measurement component 140 may include configuration component 142 configured to receive, from a current serving cell, a configuration of a channel state information (CSI) reference signal (RS) measurement resource for layer 1 (L1) measurements of a candidate cell. The L1 measurement component 140 may include a measurement component 144 configured to measure a signal transmitted from the candidate cell based on whether the candidate cell is an intra-frequency candidate cell or an inter-frequency candidate cell. In some implementations, the L1 measurement component may optionally include a reporting component 146 configured to transmit a L1 CSI report including measurements of the candidate cell.

In some implementations, one or more of the base stations 102 may include a measurement control component 120 configured to manage a L1 measurements for a UE. The measurement control component 120 may include a configuration Tx component 122 configured to transmit, from a current serving cell, a configuration of a channel state information (CSI) reference signal (RS) measurement resource for layer 1 (L1) measurements of a candidate cell. The configuration is based on whether the candidate cell is an intra-frequency candidate cell or an inter-frequency candidate cell. The measurement control component 120 may include a report Rx component 124 configured to receive a L1 CSI report including measurements of the candidate cell.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHZ-300 GHZ) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

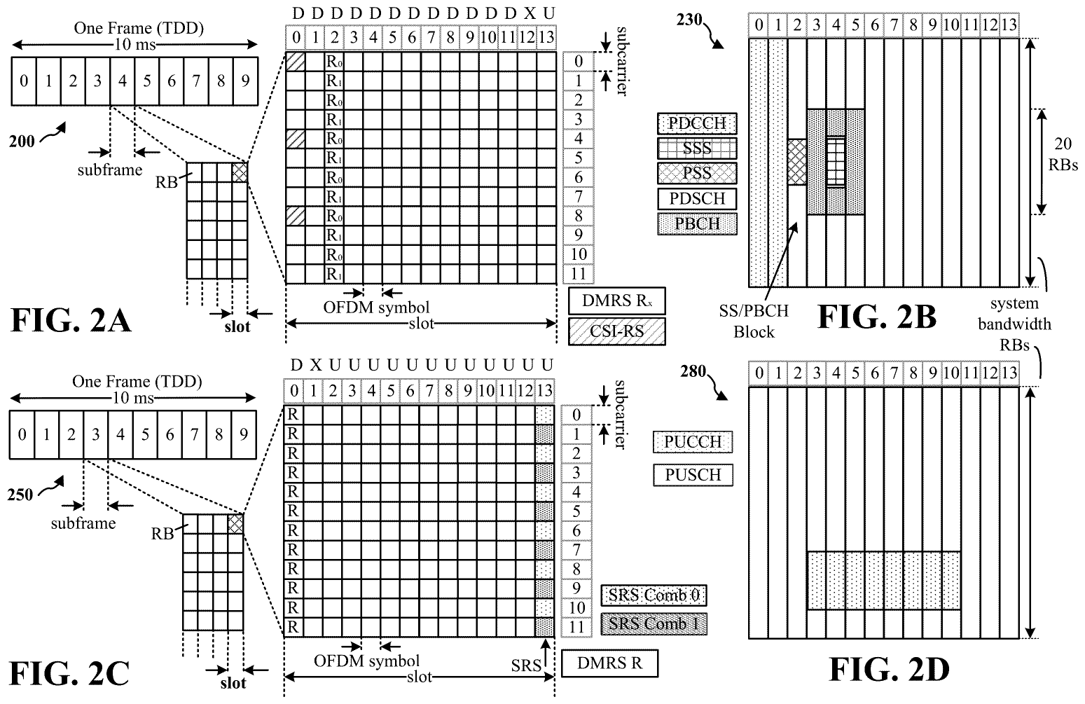

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 24 * 15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), cach CCE including nine RE groups (REGs), cach REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

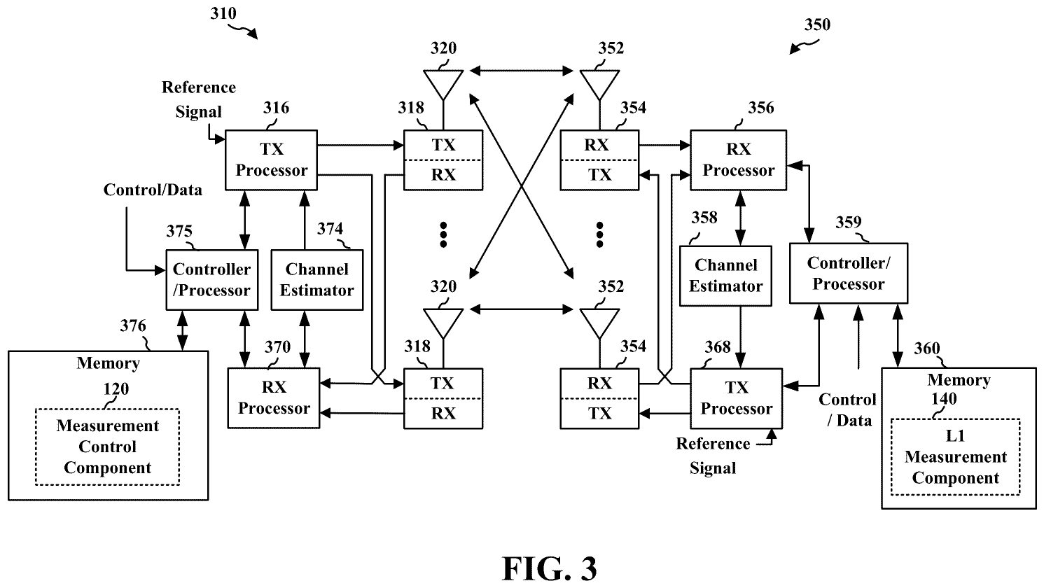

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging. RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. . IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the L1 measurement component 140 of FIG. 1. For example, the memory 360 may include executable instructions defining the L1 measurement component 140. The TX processor 368, the RX processor 356, and/or the controller/processor 359 may be configured to execute the L1 measurement component 140.

At least one of the TX processor 316, the RX processor 370, and the controller/processor 375 may be configured to perform aspects in connection with the measurement control component 120 of FIG. 1. For example, the memory 376 may include executable instructions defining the measurement control component 120. The TX processor 316, the RX processor 370, and/or the controller/processor 375 may be configured to execute the measurement control component 120.

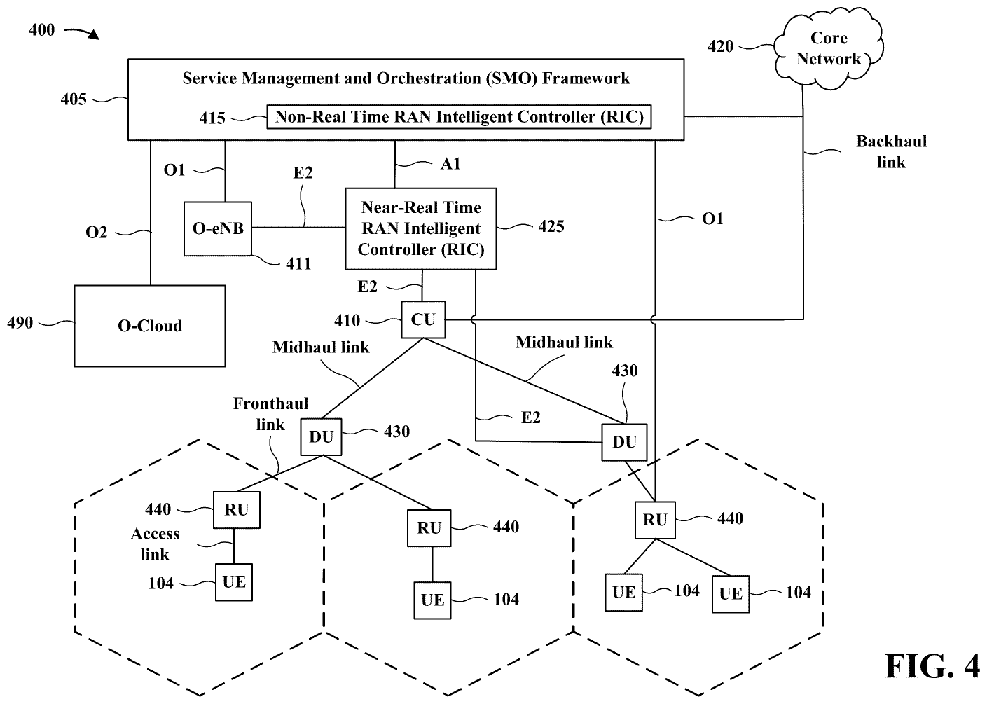

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the El interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network clements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an Al interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as Al policies).

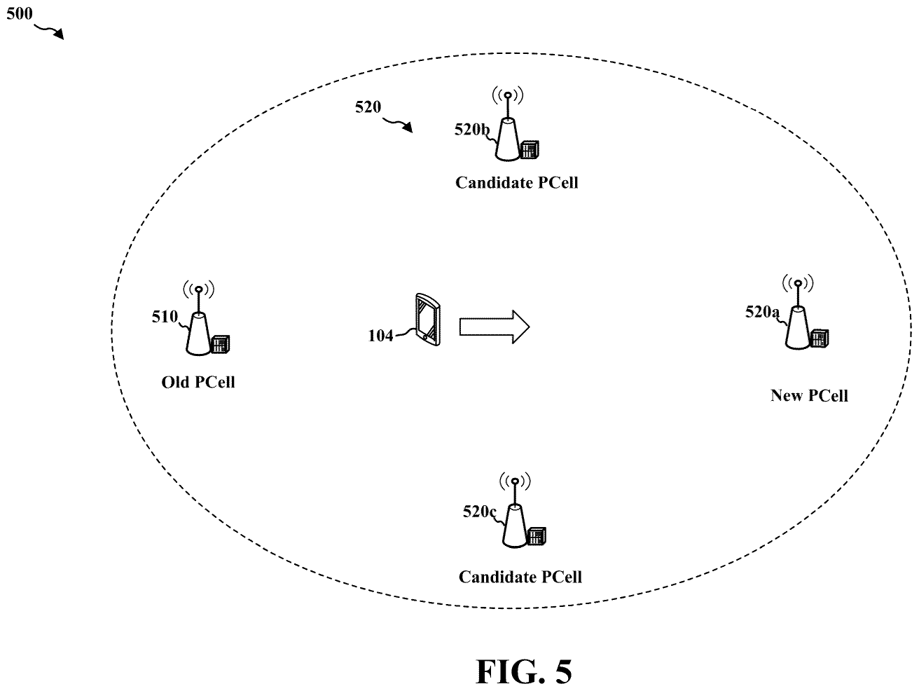

FIG. 5 is a diagram illustrating an example of a L1/L2 mobility scenario 500 for primary cells (PCells). A UE 104 may initially be served by an active PCell 510. L1/L2 mobility may allow the PCell to be updated via L1/L2 signaling based on L1 measurements. The scenario 500 may apply to a single PCell change without carrier aggregation (CA). L1/L2 mobility may apply to both intra-frequency mobility and inter-frequency mobility.

During a L1/L2 mobility procedure, the UE 104 may determine a target candidate cell (e.g., new PCell 520a) from a set of candidate cells 520. For example, the set of candidate cells 520 may include candidate PCells 520a, 520b, and 520c. The target candidate PCell 520a may be selected based on, for example, L1 measurement.

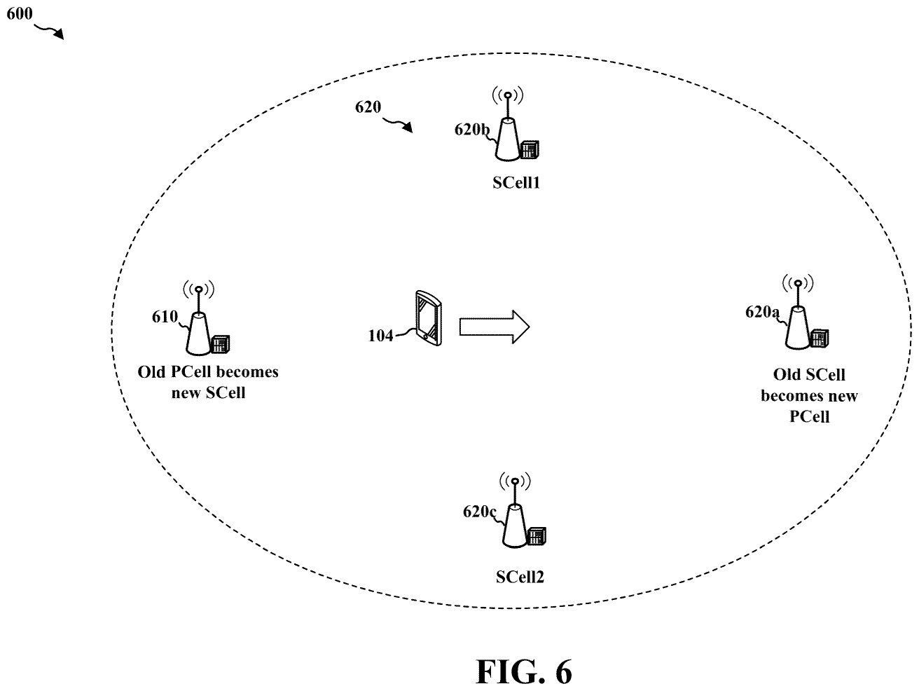

FIG. 6 is a diagram illustrating an example of a L1/L2 mobility scenario 600 for secondary cell (SCell) switching. Similar to the PCell scenario, the UE 104 may initially be served by an active PCell 610. The active PCell 610 may be in CA with SCells 620. During a L1/L2 mobility procedure, the UE 104 may determine a target candidate SCell (e.g., new SCell 620a) from a set of candidate SCells 620. For example, the set of candidate SCells 620 may include candidate SCells 620a, 620b, and 620c, which are configured as SCells in CA with the PCell 610. The target candidate SCell 620a may be selected based on, for example, L1 measurement. The L1/L2 mobility procedure may switch the candidate SCell 620a to become the new PCell. In some implementations, the old PCell 610 may become an SCell, or may no longer be used as a serving cell (e.g., due to poor channel conditions).

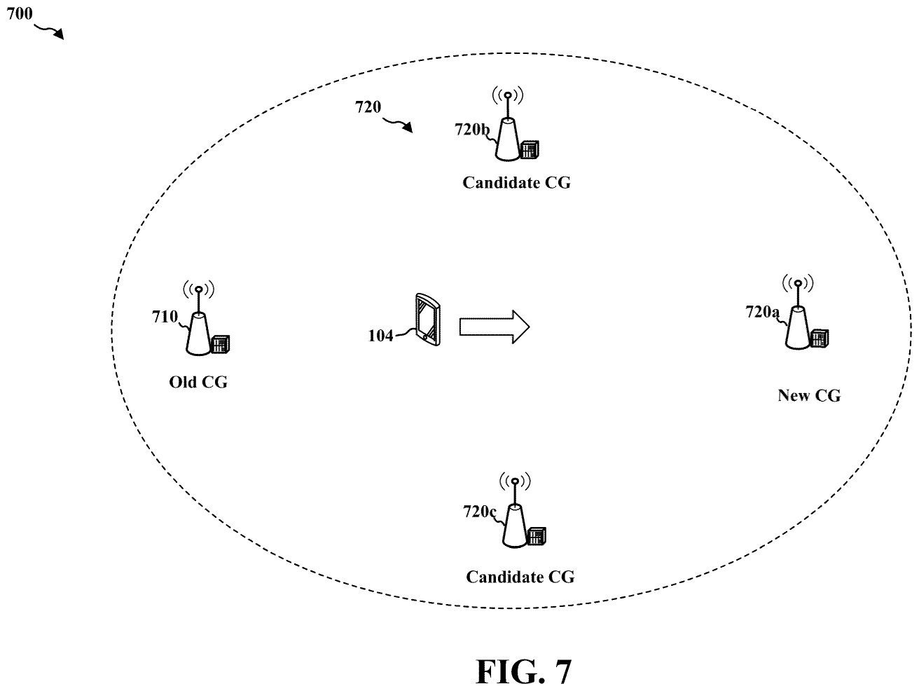

FIG. 7 is a diagram illustrating an example of a L1/L2 mobility scenario 700 for cell groups (CGs). When the UE 104 is configured with cell groups, the special cell (SpCell) and the SCells may be switched as a group. For example, the current serving CG 710 may include the SpCell and SCells. The set of candidate CGs 720 may include candidate CGs 720a, 720b, and 720c. L1/L2 mobility may allow the serving CG 710 to be updated via L1/L2 signaling based on L1 measurements. The target candidate CG 720a may be selected based on, for example, L1 measurement. The L1/L2 mobility procedure may switch the candidate CG 720a to become the new serving CG.

L1/L2 mobility may include mechanisms and procedures of L1/L2 based inter-cell mobility for mobility latency reduction. For example, configuration and maintenance for multiple candidate cells may allow fast application of configurations for candidate cells 520. A dynamic switch mechanism among candidate serving cells (including PCells, SCells, and SpCells) may satisfy multiple potential applicable scenarios based on L1/L2 signaling. L1 enhancements for inter-cell beam management, including L1 measurement and reporting, and beam indication may facilitate L1/L2 mobility. Timing Advance management for candidate cells may facilitate L1/L2 mobility. CU-DU interface signaling to support L1/L2 mobility may be applicable in a distributed architecture. Example L1/L2 mobility scenarios include: Standalone, CA and NR-DC cases with serving cell change within one cell group (CG); Intra-DU case and intra-CU inter-DU case (applicable for Standalone and CA); both intra-frequency and inter-frequency mobility; both FR1 and FR2 frequency ranges; and when source and target cells are synchronized or non-synchronized.

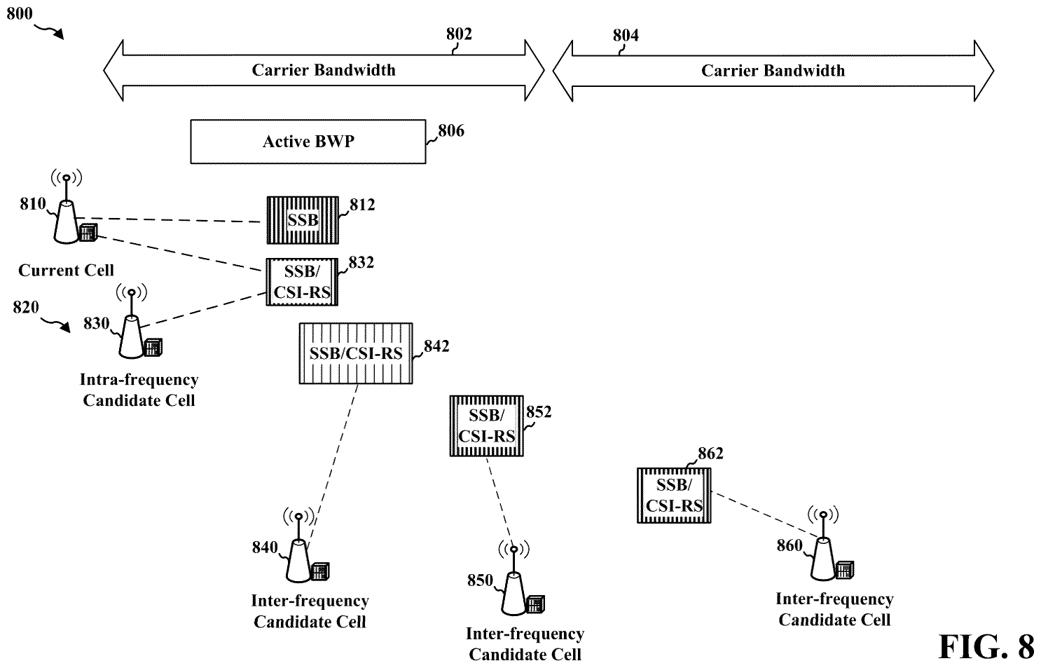

FIG. 8 is a diagram 800 illustrating transmission of synchronization signal blocks (SSB) and/or CSI-RS for both intra-frequency and inter-frequency mobility. The active serving cell 810 (e.g., PCell 510, PCell 610, or CG 710) may transmit an SSB 812 on a center frequency within a configured active bandwidth part (BWP) 806 within a carrier bandwidth 802. Various candidate cells 820 may include intra-frequency candidate cell 830, and inter-frequency candidate cells 840, 850, or 860.

An intra-frequency candidate cell 830 may be a candidate cell that operates on the same carrier bandwidth 802, active BWP 806, center frequency, and has the same subcarrier spacing (SCS) as the active serving cell 810. For example, a definition of an L3 intra-frequency measurement is defined as a SSB based intra-frequency measurement provided the center frequency of the SSB of the serving cell indicated for measurement and the center frequency of the SSB of the neighbor cell are the same, and the subcarrier spacing of the two SSBs are also the same. For L3 measurements, the SSB need not be in the active BWP of the serving cell.

In NR release 17, only a narrow class of L1 intra-frequency measurements of a non-serving cell are allowed. For example, a UE can be configured in a serving cell configuration with a CSI-RS whose TCI is quasi-co-located with a non-serving cell SSB. The non-serving cell CSI-RS, however, is restricted to having, for example, the same scrambling seed, aligned Point A configuration, same SCS, aligned center frequency, and system frame number (SFN) offset with the serving cell. Accordingly, the configurable L1 intra-frequency measurements of NR Release 17 may not be suitable for L1/L2 mobility procedures with various types of cells.

In an aspect, a definition of an intra-frequency cell for L1 measurements may be relaxed or expanded. For example, an L1 measurement of a candidate cell may be configured in the current serving cell as non-serving cell CSI-RS must be configured in the active DL BWP, but at least some of the configuration need not follow the serving cell: For instance, the SCS and center frequency must be same as serving cell, but scrambling sequence seed may follow the scrambling sequence seed of the non-serving cell. Similarly, the Point A configuration or SFN offset may vary. As another example, the L3 definition of intra-frequency cell (e.g., same center frequency and SCS) may be applied with optional additional limitations such as a same BWP, a same SFN offset, or other BWP parameters.

A UE may perform intra-frequency measurements of candidate cells that meet the expanded definition. In some implementations, no measurement gap is needed for such intra-frequency measurements. In some implementations, however, a receive timing difference between the serving cell and a candidate cell may be greater than a cyclic prefix (CP) length according to the SCS of the candidate cell. In that case, a symbol level gap may be used to allow the UE to adjust timing to receive a complete symbol. A symbol gap may be configured before and/or after consecutive SSB/CSI RS symbols for inter-frequency measurement (e.g. in a SSB measurement timing configuration (SMTC) window. A measurement gap may be configured when the non-serving cell CSI-RS is outside of a downlink active BWP for some definitions of intra-frequency cell.

In an aspect, any cell that does not meet the definition of an intra-frequency cell may be considered an inter-frequency cell. For instance, inter-frequency cells may include the following scenarios: 1) the frequency of the measured RS not covered by any of the active BWPs of SpCell and Scells configured for a UE, but covered by some of the configured BWPs of SpCell and Scells configured for a UE; and 2) the frequency of the measured RS not covered by any of the configured BWPs of SpCell and Scells configured for a UE. Conventionally, L1 measurements of inter-frequency cells cannot be configured.

A first type of inter-frequency candidate cell 850 may transmit an SSB or CSI-RS 852 outside of the active BWP 806 of the active serving cell 810 but within the configured carrier bandwidth 802 of the active serving cell 810.

As another example, a second type of inter-frequency candidate cell 860 may transmit an SSB or CSI-RS 862 outside of the configured carrier bandwidth 802 of the active serving cell 810 (e.g., in a carrier bandwidth 804).

As another example, a third type of inter-frequency candidate cell 840 may be a candidate cell that differs in center frequency, SCS, active BWP, or carrier bandwidth 802 from the active serving cell 810. For instance, the inter-frequency candidate cell 840 may transmit an SSB or CSI-RS 842 within an active BWP 806 of the active serving cell 810 but with a center frequency or SCS that is different than the SSB 812 of the active serving cell 810.

In an aspect, a UE 104 may be able to perform SSB/CSI-RS based inter-frequency measurement without measurement gaps when the inter-frequency SSB/CSI-RS 842 is completely contained in the active DL BWP of the serving cell. A UE may indicate a capability to perform inter-frequency measurements without measurement gaps on inter-frequency cells 840. The capability may indicate a limit on SCS or timing difference. In an aspect, it may be assumed that a UE is configured to perform SSB/CSI based inter-frequency measurement with a measurement gap when the inter-frequency SSB/CSI-RS 852 or 862 is outside of the active DL BWP 806 of the serving cell. Additionally, a SMTC or measurement gap may be configured if Tx timing of serving and candidate cell is not aligned (e.g., RRC flag deriveSSB-IndexFromCell is disabled). The measurement gap may be configured before and/or after consecutive SSB/CSI RS symbols for inter-frequency measurement (e.g. in the SMTC window).

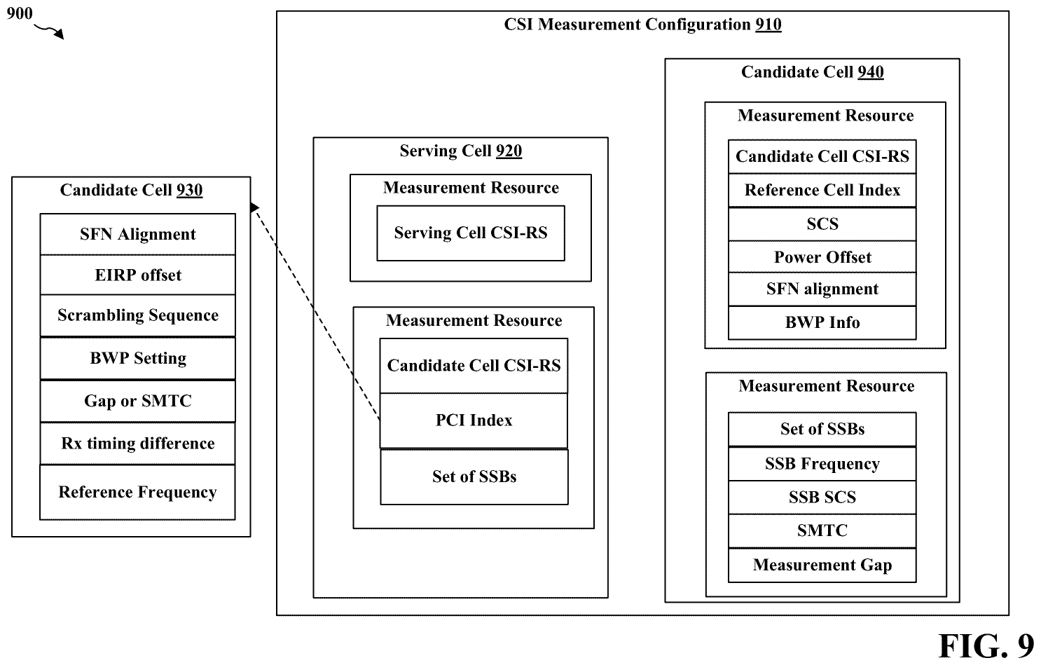

FIG. 9 is a diagram of an example RRC configuration 900 for L1 measurements of candidate cells. In an aspect, the RRC configuration 900 may include a CSI measurement configuration 910.

In some implementations, the configuration of the CSI-RS measurement resource for a candidate cell may be included within a configuration of the serving cell 920. For example, the serving cell 920 may include a measurement resource for the serving cell CSI-RS and a measurement resource for a candidate cell CSI-RS or SSB. The measurement resource for the candidate cell may include a PCI index. The PCI index may identify a separate configuration of the candidate cell 930 (e.g., a L3 measurement object). Parameters for the L1 measurement object may be defined in the separate configuration of the candidate cell 930. For example, the separate configuration of the candidate cell 930 may indicate one or more of: alignment of SFN; an effective isotropic radiated power (EIRP) offset from the current serving cell; a scrambling sequence; a BWP setting of the candidate cell; whether the candidate cell is configured with a symbol level gap or SSB measurement timing configuration (SMTC); or an assumed receive timing difference between the candidate cell and the current serving cell. In some implementations, the configuration of the candidate cell 930 may include a reference frequency CSI-RS. In some implementations, the configuration of the candidate cell 930 indicates a measurement gap configuration, a sub-carrier spacing, a power offset, an SFN alignment with the serving cell, or bandwidth part information

In some implementations, the CSI measurement configuration 910 may include candidate cell configuration 940 that includes measurement resources for the candidate cell. The measurement resource may correspond to a SSB or CSI-RS for mobility. For instance, a measurement resource corresponding to an SSB may indicate a set of SSBs to be measured, an SSB frequency, an SSB sub-carrier spacing, and/or a SMTC. The measurement resource for the SSB may include a measurement gap configuration. A measurement resource corresponding to a CSI-RS may include a reference cell index identifying a reference cell for timing. The measurement resource corresponding to a CSI-RS may include one or more of: a sub-carrier spacing, a power offset, an SFN alignment with the serving cell, or bandwidth part information.

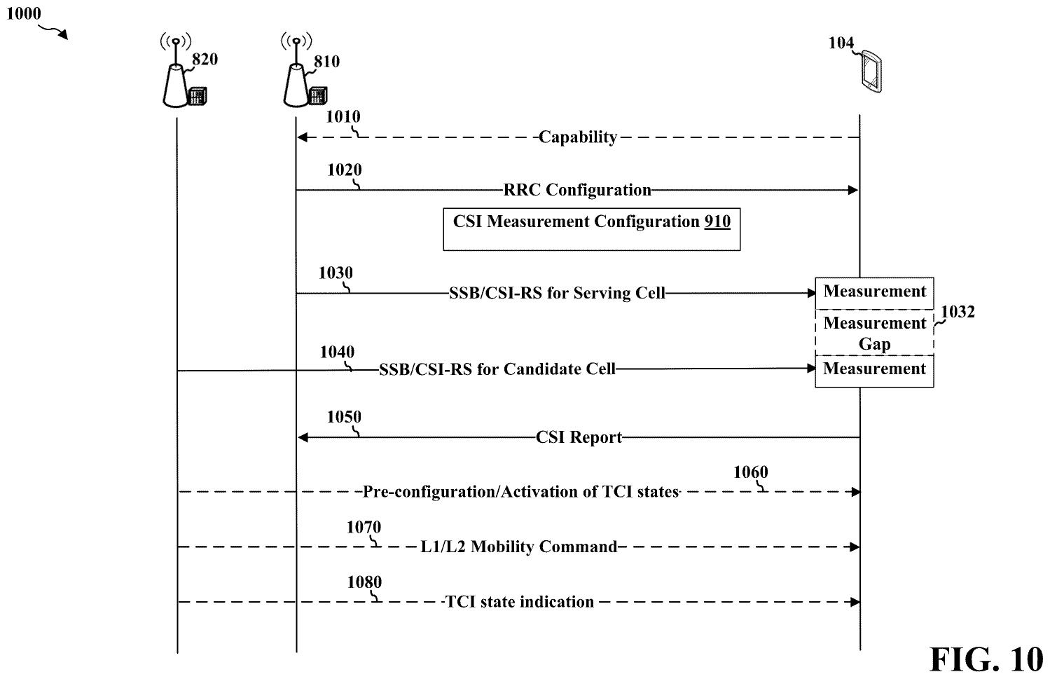

FIG. 10 is a message diagram 1000 illustrating various messages for L1 measurements. The UE 104 may transmit a capability message 1010 that indicates a capability of the UE to perform L1 measurements.

The serving cell 810 may transmit an RRC configuration 1020. The RRC configuration 1020 may configure a channel CSI-RS measurement resource for L1 measurements of a candidate cell. For instance, the RRC configuration 1020 may include the CSI measurement configuration 910.

The serving cell 810 may transmit an SSB/CSI-RS 1030 for the serving cell. For instance, the SSB/CSI-RS 1030 may correspond to the SSB 812. The UE 104 may perform L1 measurements (e.g., measure L1 reference signal received power (RSRP) or L1 signal to noise plus interference ratio (SINR) of the SSB/CSI-RS 1030. In some implementations, a measurement gap 1032 may allow the UE 104 to adjust timing and/or frequency before a candidate cell 820 transmits an SSB/CSI-RS 1040 on a configured measurement resource. For example, the SSB/CSI-RS 1040 may correspond to any of the SSB/CSI-RS 832, 842, 852, or 862. The UE 104 may measure the SSB/CSI-RS 1040 of the candidate cell to obtain L1 measurements such as L1 RSRP or L1 SINR. In an aspect, the measurement may be based on whether the candidate cell is an intra-frequency candidate cell or an inter-frequency candidate cell. For example, the presence or length of the measurement gap 1032 may be based on the type of candidate cell.

In some implementations, the UE 104 may transmit a CSI report 1050 that includes L1 measurements of the candidate cell 820. The UE 104, the serving cell 810 and/or the candidate cell may determine whether to perform an L1/L2 mobility procedure based on the CSI report 1050.

In an example L1/L2 mobility procedure, the serving cell 810 and/or candidate cell 820 may transmit a message 1060 to preconfigure or active TCI states. For example, the message 1060 may include an RRC configuration and/or a MAC-CE. The serving cell 810 and/or candidate cell 820 may transmit an L1/L2 mobility command 1070 (e.g., a MAC-CE or DCI) that indicates the UE to switch to the candidate cell 820. The candidate cell 820 (now the new serving cell) may transmit a TCI state indication 1080 (e.g., a DCI) to inform the UE of a TCI state to use for communications with the new serving cell.

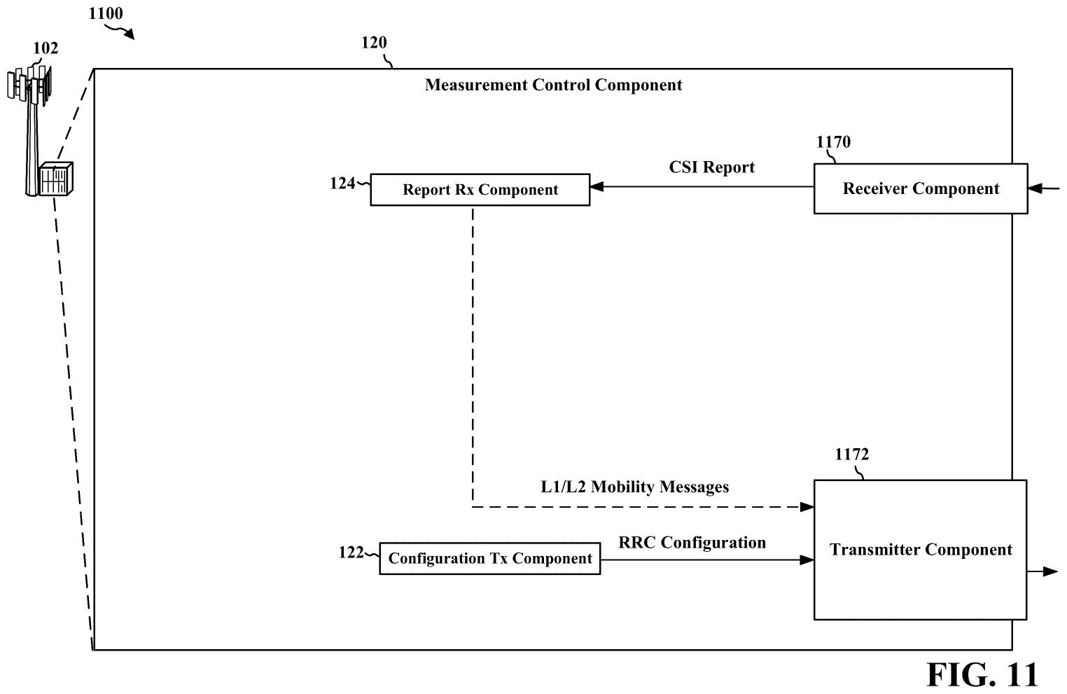

FIG. 11 is a conceptual data flow diagram 1100 illustrating the data flow between different means/components in an example base station 102, which may be an example of the base station 102 (FIG. 1) including the measurement control component 120. The measurement control component 120 may be implemented by the memory 376 and the TX processor 316, the RX processor 370, and/or the controller/processor 375 of FIG. 3. For example, the memory 376 may store executable instructions defining the measurement control component 120 and the TX processor 316, the RX processor 370, and/or the controller/processor 375 may execute the instructions.

The base station 102 may include a receiver component 1170, which may include, for example, a radio frequency (RF) receiver for receiving the signals described herein. The base station 102 may include a transmitter component 1172, which may include, for example, an RF transmitter for transmitting the signals described herein. In an aspect, the receiver component 1170 and the transmitter component 1172 may co-located in a transceiver such as illustrated by the TX/RX 318 in FIG. 3.

As discussed with respect to FIG. 1, the measurement control component 120 may include the configuration Tx component 122 and the report Rx component 124.

The receiver component 1170 may receive UL signals from the UE 104 the capability message 1010 and the CSI report 1050. The receiver component 1170 may provide the capability message 1010 to the configuration Tx component 122. The receiver component 1170 may provide the CSI report 1050 to the report Rx component 124. message to the report Rx component 124.

The configuration Tx component 122 may be configured to transmit, from a current serving cell, a configuration of a CSI-RS measurement resource for L1 measurements of a candidate cell. In some implementations, the configuration Tx component 122 may obtain the capability message 1010. The configuration Tx component 122 may determine that the UE 104 is capable of L1 measurements based on the capability message 1010. The configuration Tx component 122 may receive information about candidate cells from the core network 190 (e.g., AMF 192). The configuration Tx component 122 may select candidate cells for the UE 104 and generate an RRC configuration 1020 identifying L1 measurement resources corresponding to the candidate cells. The configuration is based on whether the candidate cell is an intra-frequency candidate cell or an inter-frequency candidate cell. For example, the configuration Tx component 122 may generate the CSI measurement configuration 910. The parameters for each measurement resource may be based on the type of the candidate cell. The configuration Tx component 122 may output the RRC configuration 1020 for transmission to the UE 104 via the transmitter component 1172.

The report Rx component 124 may be configured to receive a L1 CSI report 1050 including measurements of the candidate cell. For example, the measurement control component 120 may obtain the L1 CSI report 1050 via the receiver component 1170. In some implementations, the report Rx component 124 may evaluate the L1 measurements.

For example, the report Rx component 124 determine whether an L1/L2 mobility condition is satisfied by the L1 measurements. In some implementations, the report Rx component 124 may output L1/L2 mobility messages such as the message 1060, the mobility command 1070, or the TCI state indication 1080 for transmission to the UE 104 via the transmitter component 1172.

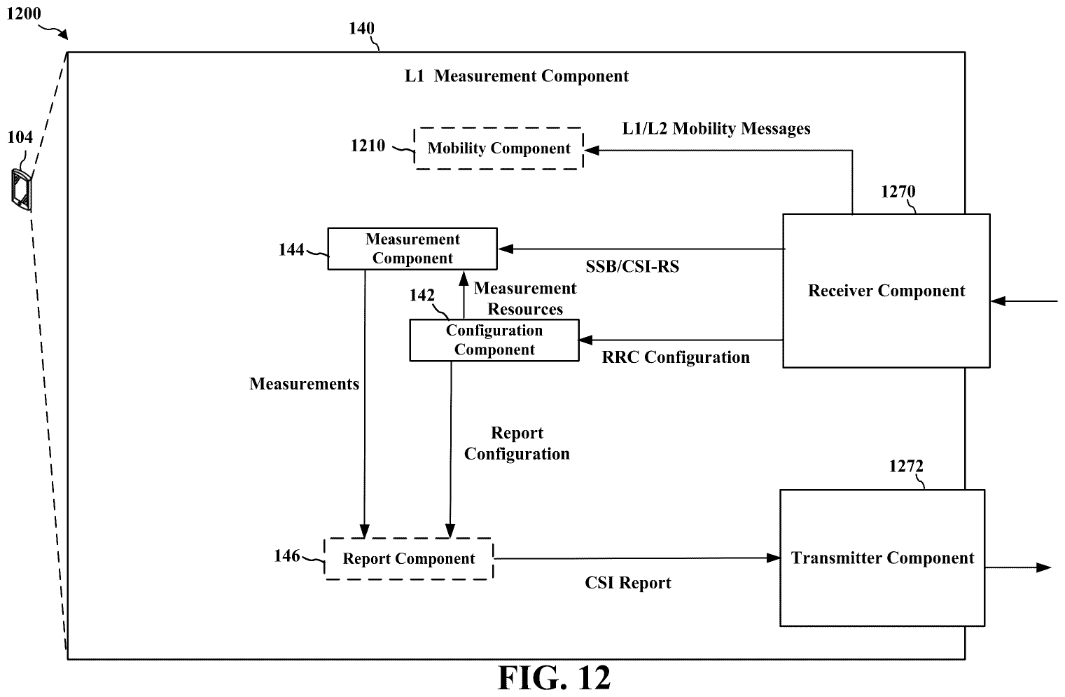

FIG. 12 is a conceptual data flow diagram 1200 illustrating the data flow between different means/components in an example UE 104, which may be an example of the UE 104 (FIG. 1) and include the L1 measurement component 140. The L1 measurement component 140 may be implemented by the memory 360 and the TX processor 368, the RX processor 356, and/or the controller/processor 359. For example, the memory 360 may store executable instructions defining the L1 measurement component 140 and the TX processor 368, the RX processor 356, and/or the controller/processor 359 may execute the instructions.

The UE 104 may include a receiver component 1270, which may include, for example, a RF receiver for receiving the signals described herein. The UE 104 may include a transmitter component 1272, which may include, for example, an RF transmitter for transmitting the signals described herein. In an aspect, the receiver component 1270 and the transmitter component 1272 may co-located in a transceiver such as the TX/RX 352 in FIG. 3.

As discussed with respect to FIG. 1, the L1 measurement component 140 may include the configuration component 142 and the measurement component 144. In some implementations, the L1 measurement component 140 may include the reporting component 146 and/or a mobility component 1210.

The receiver component 1270 may receive DL signals described herein such as the RRC configuration 1020, the SSB/CSI-RS 1030, the SSB/CSI-RS 1040, the message 1060, the mobility command 1070, or the TCI state indication 1080. The receiver component 1270 may provide the RRC configuration 1020 to the configuration component 142. The receiver component 1270 provide the SSB/CSI-RS 1030 and/or the SSB/CSI-RS 1040 to the measurement component 144. The receiver component 1270 may provide the message 1060, the mobility command 1070, or the TCI state indication 1080 to the mobility component 1210.

The configuration component 142 may be configured to receive, from a current serving cell, a configuration of a CSI-RS measurement resource for L1 measurements of a candidate cell. For example, the configuration component 142 may receive the RRC configuration 1020 via the receiver component 1270. The configuration component 142 may determine the CSI-RS measurement resource for L1 measurements of the candidate cell based on the information elements of the RRC configuration 1020. The configuration component 142 may output the measurement resources to the measurement component 144. The configuration component 142 may output a report configuration to the reporting component 146.

The measurement component 144 may be configured to measure a signal transmitted from the candidate cell based on whether the candidate cell is an intra-frequency candidate cell or an inter-frequency candidate cell. For example, the measurement component 144 may receive the SSB/CSI-RS 1030, 1040 via the receiver component 1270. In some implementations, the measurement component 144 may tune the receiver component 1270 to a correct frequency to receive an inter-frequency SSB/CSI-RS. In some implementations, the measurement component 144 may adjust a timing for receiving an SSB/CSI-RS. The measurement component 144 may determine measurements such as L1 RSRP or L1 SINR based on the received SSB/CSI-RS. The measurement component 144 may output the measurements to the reporting component 146 and/or the mobility component 1210.

The reporting component 146 may be configured to transmit a L1 CSI report 1050 including measurements of the candidate cell. For example, the reporting component 146 may obtain a report configuration from the configuration component 142. The reporting component 146 may obtain the measurements from the measurement component 144. The reporting component 146 may include the configured measurements in the CSI report 1050. The reporting component 146 may output the CSI report 1050 for transmission via the transmitter component 1272.

The mobility component 1210 may be configured to perform an L1/L2 mobility procedure. The mobility component 1210 may receive mobility messages via the receiver component 1270. For example, the mobility component 1210 may receive the message 1060, the mobility command 1070, and/or the TCI state indication 1080. The mobility component 1210 may configure the UE 104 as indicated in the L1/L2 mobility messages.

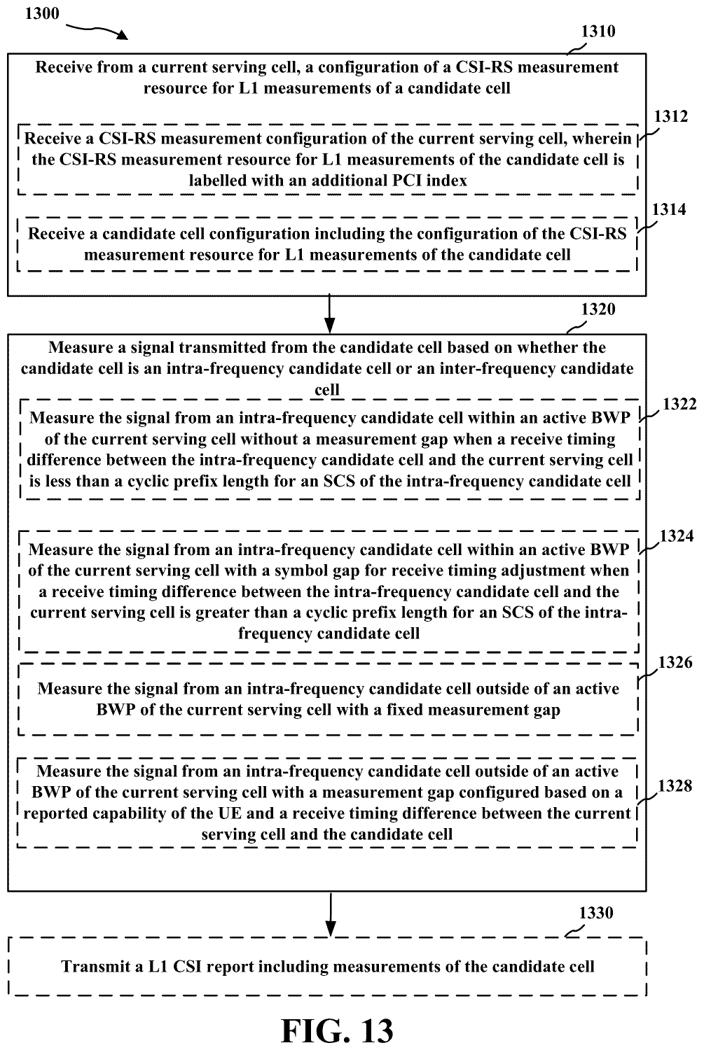

FIG. 13 is a flowchart of an example method 1300 for a UE to perform L1 measurements of candidate cells. The method 1300 may be performed by a UE (such as the UE 104, which may include the memory 360 and which may be the entire UE 104 or a component of the UE 104 such as the L1 measurement component 140, TX processor 368, the RX processor 356, or the controller/processor 359). The method 1300 may be performed by the L1 measurement component 140 in communication with the measurement control component 120 of the base station 102. Optional blocks are shown with dashed lines.

At block 1310, the method 1300 may include receiving from a current serving cell, a configuration of a CSI-RS measurement resource for L1 measurements of a candidate cell. In some implementations, for example, the UE 104, the RX processor 356 or the controller/processor 359 may execute the L1 measurement component 140 or the configuration component 142 to receive from a current serving cell, a configuration of a CSI-RS measurement resource for L1 measurements of a candidate cell. In some implementations, the CSI-RS measurement resource for L1 measurements of an intra-frequency candidate cell is configured in an active downlink BWP of the current serving cell, where at least one of a scrambling seed, aligned point A configuration, a sub-carrier spacing, a center frequency, or a SFN offset is different than the current serving cell. In some implementations, the CSI-RS resource for L1 measurements of an intra-frequency candidate cell has a same center frequency and a same sub-carrier spacing as a CSI-RS resource for the serving cell. In some implementations, the CSI-RS resource for L1 measurements of the intra-frequency candidate cell is in an active BWP of the current serving cell or has a same SFN offset as the current serving cell. In some implementations, at sub-block 1312, the block 1310 may optionally include receiving a CSI-RS measurement configuration of the current serving cell, wherein the CSI-RS measurement resource for L1 measurements of the candidate cell is labelled with an additional PCI index. The additional PCI index may be linked to a configuration of the candidate cell 930. In some implementations, the configuration of the candidate cell 930 indicates one or more of: alignment of SFN; an EIRP offset from the current serving cell; scrambling sequence; BWP setting of the candidate cell; whether the candidate cell is configured with a symbol level gap or SMTC; or an assumed receive timing difference between the candidate cell and the current serving cell. In some implementations, the configuration of an inter-frequency candidate cell includes a reference frequency CSI-RS. In some implementations, the configuration of the candidate cell indicates one or more of: a measurement gap configuration, a sub-carrier spacing, a power offset, an SFN alignment with the serving cell, or bandwidth part information. In some implementations, at sub-block 1314, the block 1310 may optionally include receiving a candidate cell configuration 940 including the configuration of the CSI-RS measurement resource for L1 measurements of the candidate cell. In some implementations, a RRC configuration includes a reference signal configuration corresponding to a SSB or a CSI-RS configured for mobility. The reference signal configuration corresponding to the SSB may include a set of SSBs to be measured. The reference signal configuration corresponding to the SSB of an inter-frequency candidate cell may include an SSB frequency, an SSB sub-carrier spacing, and a SMTC. The reference signal configuration corresponding to the SSB of the inter-frequency candidate cell may further include an associated measurement gap configuration. In some implementations, the reference signal configuration corresponding to a CSI-RS includes a reference cell index identifying a reference cell for timing. In some implementations, the reference signal configuration corresponding to a CSI-RS includes one or more of: a sub-carrier spacing, a power offset, an SFN alignment with the serving cell, or bandwidth part information. Accordingly, the UE 104, the RX processor 356, or the controller/processor 359 executing the L1 measurement component 140 or the configuration component 142 may provide means for receiving from a current serving cell, a configuration of a CSI-RS measurement resource for L1 measurements of a candidate cell.

At block 1320, the method 1300 includes measuring a signal transmitted from the candidate cell based on whether the candidate cell is an intra-frequency candidate cell or an inter-frequency candidate cell. In some implementations, for example, the UE 104, the RX processor 356 or the controller/processor 359 may execute the L1 measurement component 140 or the measurement component 144 to measuring a signal transmitted from the candidate cell based on whether the candidate cell is an intra-frequency candidate cell or an inter-frequency candidate cell. In some implementations, at sub-block 1322, the block 1320 may optionally include measuring the signal from an intra-frequency candidate cell within an active BWP of the current serving cell without a measurement gap when a receive timing difference between the intra-frequency candidate cell and the current serving cell is less than a cyclic prefix length for an SCS of the intra-frequency candidate cell. In some implementations, at sub-block 1324, the block 1320 may optionally include measuring the signal from an intra-frequency candidate cell within an active BWP of the current serving cell with a symbol gap for receive timing adjustment when a receive timing difference between the intra-frequency candidate cell and the current serving cell is greater than a cyclic prefix length for an SCS of the intra-frequency candidate cell. In some implementations, at sub-block 1326, the block 1320 may optionally include measuring the signal from an intra-frequency candidate cell outside of an active BWP of the current serving cell with a fixed measurement gap. In some implementations, at sub-block 1328, the block 1320 may optionally include measuring the signal from an intra-frequency candidate cell outside of an active BWP of the current serving cell with a measurement gap configured based on a reported capability of the UE and a receive timing difference between the current serving cell and the candidate cell. Accordingly, the UE 104, the RX processor 356, or the controller/processor 359 executing the L1 measurement component 140 or measurement component 144 may provide means for measuring a signal transmitted from the candidate cell based on whether the candidate cell is an intra-frequency candidate cell or an inter-frequency candidate cell.

At block 1330, the method 1300 may optionally include transmitting a L1 CSI report including measurements of the candidate cell. In some implementations, for example, the UE 104, the TX processor 368, or the controller/processor 359 may execute the L1 measurement component 140 or the reporting component 146 to transmit a L1 CSI report including measurements of the candidate cell. Accordingly, the UE 104, the TX processor 368, or the controller/processor 359 executing the L1 measurement component 140 or the reporting component 146 may provide means for transmitting a L1 CSI report including measurements of the candidate cell.

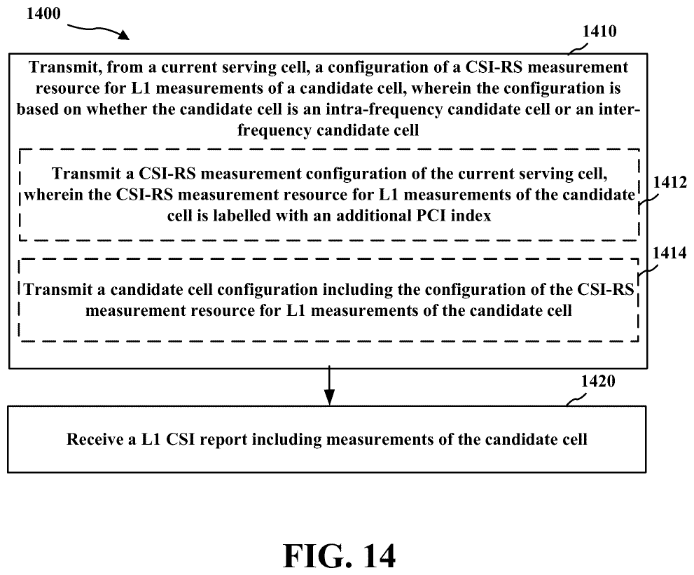

FIG. 14 is a flowchart of an example method 1400 for a network node to configure a UE to perform L1 measurements of candidate cells. The method 1400 may be performed by a network node (such as the base station 102, which may include the memory 376 and which may be the entire base station 102 or a component of the base station 102 such as the measurement control component 120, the TX processor 316, the RX processor 370, or the controller/processor 375). The method 1400 may be performed by the measurement control component 120 in communication with the L1 measurement component 140 of the UE 104.

At block 1410, the method 1400 includes transmitting, from a current serving cell, a configuration of a CSI-RS measurement resource for L1 measurements of a candidate cell, wherein the configuration is based on whether the candidate cell is an intra-frequency candidate cell or an inter-frequency candidate cell. In some implementations, for example, the base station 102, the TX processor 316, or the controller/processor 375 may execute the measurement control component 120 or the configuration Tx component 122 to transmit, from a current serving cell, a configuration of a CSI-RS measurement resource for L1 measurements of a candidate cell, wherein the configuration is based on whether the candidate cell is an intra-frequency candidate cell or an inter-frequency candidate cell. In some implementations, the CSI-RS measurement resource for L1 measurements of an intra-frequency candidate cell is configured in an active downlink BWP of the current serving cell, where at least one of a scrambling seed, aligned point A configuration, a sub-carrier spacing, a center frequency, or a SFN offset is different than the current serving cell. In some implementations, the CSI-RS resource for L1 measurements of an intra-frequency candidate cell has a same center frequency and a same sub-carrier spacing as a CSI-RS resource for the serving cell. In some implementations, the CSI-RS resource for L1 measurements of the intra-frequency candidate cell is in an active BWP of the current serving cell or has a same SFN offset as the current serving cell. In some implementations, at sub-block 1412, the block 1410 may optionally include transmitting a CSI-RS measurement configuration of the current serving cell, wherein the CSI-RS measurement resource for L1 measurements of the candidate cell is labelled with an additional PCI index. The additional PCI index may be linked to a configuration of the candidate cell 930. In some implementations, the configuration of the candidate cell 930 indicates one or more of: alignment of SFN; an EIRP offset from the current serving cell; scrambling sequence; BWP setting of the candidate cell; whether the candidate cell is configured with a symbol level gap or SMTC; or an assumed receive timing difference between the candidate cell and the current serving cell. In some implementations, the configuration of an inter-frequency candidate cell includes a reference frequency CSI-RS. In some implementations, the configuration of the candidate cell indicates one or more of: a measurement gap configuration, a sub-carrier spacing, a power offset, an SFN alignment with the serving cell, or bandwidth part information. In some implementations, at sub-block 1414, the block 1410 may optionally include transmitting a candidate cell configuration 940 including the configuration of the CSI-RS measurement resource for L1 measurements of the candidate cell. In some implementations, a RRC configuration includes a reference signal configuration corresponding to a SSB or a CSI-RS configured for mobility. The reference signal configuration corresponding to the SSB may include a set of SSBs to be measured. The reference signal configuration corresponding to the SSB of an inter-frequency candidate cell may include an SSB frequency, an SSB sub-carrier spacing, and a SMTC. The reference signal configuration corresponding to the SSB of the inter-frequency candidate cell may further include an associated measurement gap configuration. In some implementations, the reference signal configuration corresponding to a CSI-RS includes a reference cell index identifying a reference cell for timing. In some implementations, the reference signal configuration corresponding to a CSI-RS includes one or more of: a sub-carrier spacing, a power offset, an SFN alignment with the serving cell, or bandwidth part information. Accordingly, the base station 102, the TX processor 316, or the controller/processor 375 executing the measurement control component 120 or the configuration Tx component 122 may provide means for transmitting, from a current serving cell, a configuration of a CSI-RS measurement resource for L1 measurements of a candidate cell, wherein the configuration is based on whether the candidate cell is an intra-frequency candidate cell or an inter-frequency candidate cell.

At block 1420, the method 1400 includes receiving a L1 CSI report including measurements of the candidate cell. In some implementations, for example, base station 102, the RX processor 370, or the controller/processor 375 may execute the measurement control component 120 or the report Rx component 124 to a L1 CSI report including measurements of the candidate cell. Accordingly, the base station 102, the RX processor 370, or the controller/processor 375 executing the measurement control component 120 or the report Rx component 124 may provide means for receiving a L1 CSI report including measurements of the candidate cell.

The following numbered clauses provide an overview of aspects of the present disclosure:

Aspect 1: A method of wireless communication at a user equipment (UE), comprising: receiving, from a current serving cell, a configuration of a channel state information (CSI) reference signal (RS) measurement resource for layer 1 (L1) measurements of a candidate cell; and measuring a signal transmitted from the candidate cell based on whether the candidate cell is an intra-frequency candidate cell or an inter-frequency candidate cell.

Aspect 2: The method of Aspect 1, wherein the CSI-RS measurement resource for L1 measurements of an intra-frequency candidate cell is configured in an active downlink bandwidth part (BWP) of the current serving cell, wherein at least one of a scrambling seed, aligned point A configuration, a sub-carrier spacing, a center frequency, or a system frame number (SFN) offset is different than the current serving cell.

Aspect 3: The method of Aspect 1, wherein the CSI-RS measurement resource for L1 measurements of an intra-frequency candidate cell has a same center frequency and a same sub-carrier spacing as a CSI-RS resource for the serving cell.

Aspect 4: The method of Aspect 3, wherein the CSI-RS measurement resource for L1 measurements of the intra-frequency candidate cell is in an active BWP of the current serving cell or has a same SFN offset as the current serving cell.

Aspect 5: The method of any of Aspects 1-4, wherein receiving, from the current serving cell, the configuration of the CSI-RS measurement resource for L1 measurements of the candidate cell comprises receiving a CSI-RS measurement configuration of the current serving cell, wherein the CSI-RS measurement resource for L1 measurements of the candidate cell is labelled with an additional physical cell identifier (PCI) index.

Aspect 6: The method of Aspect 5, wherein the additional PCI index is linked to a configuration of the candidate cell.

Aspect 7: The method of Aspect 6, wherein the configuration of the candidate cell indicates one or more of: alignment of SFN; an effective isotropic radiated power (EIRP) offset from the current serving cell; scrambling sequence; BWP setting of the candidate cell; whether the candidate cell is configured with a symbol level gap or SSB measurement timing configuration (SMTC); or an assumed receive timing difference between the candidate cell and the current serving cell.

Aspect 8: The method of Aspect 6 or 7, wherein the configuration of an inter-frequency candidate cell includes a reference frequency CSI-RS.

Aspect 9: The method of Aspect 8, wherein the configuration of the candidate cell indicates one or more of: a measurement gap configuration, a sub-carrier spacing, a power offset, an SFN alignment with the serving cell, or bandwidth part information.

Aspect 10: The method of any of Aspects 1-4, wherein receiving, from the current serving cell, the configuration of the CSI-RS measurement resource for L1 measurements of the candidate cell comprises receiving a candidate cell configuration including the configuration of the CSI-RS measurement resource for L1 measurements of the candidate cell.

Aspect 11: The method of Aspect 10, wherein a radio resource control (RRC) configuration includes a reference signal configuration corresponding to a synchronization signal block (SSB) or a CSI-RS configured for mobility.

Aspect 12: The method of Aspect 11, wherein the reference signal configuration corresponding to the SSB includes a set of SSBs to be measured.

Aspect 13: The method of Aspect 11 or 12, wherein the reference signal configuration corresponding to the SSB of an inter-frequency candidate cell includes an SSB frequency, an SSB sub-carrier spacing, and a SMTC.

Aspect 14: The method of Aspect 13, wherein the reference signal configuration corresponding to the SSB of the inter-frequency candidate cell further includes an associated measurement gap configuration.

Aspect 15: The method of Aspect 11, wherein the reference signal configuration corresponding to a CSI-RS includes a reference cell index identifying a reference cell for timing.

Aspect 16: The method of Aspect 11, wherein the reference signal configuration corresponding to a CSI-RS includes one or more of: a sub-carrier spacing, a power offset, an SFN alignment with the serving cell, or bandwidth part information.

Aspect 17: The method of any of Aspects 1-16, wherein measuring the signal transmitted from the candidate cell based on whether the candidate cell is an intra-frequency candidate cell or an inter-frequency candidate cell comprises measuring the signal from an intra-frequency candidate cell within an active BWP of the current serving cell without a measurement gap when a receive timing difference between the intra-frequency candidate cell and the current serving cell is less than a cyclic prefix length for an SCS of the intra-frequency candidate cell.

Aspect 18: The method of any of Aspects 1-16, wherein measuring the signal transmitted from the candidate cell based on whether the candidate cell is an intra-frequency candidate cell or an inter-frequency candidate cell comprises measuring the signal from an intra-frequency candidate cell within an active BWP of the current serving cell with a symbol gap for receive timing adjustment when a receive timing difference between the intra-frequency candidate cell and the current serving cell is greater than a cyclic prefix length for an SCS of the intra-frequency candidate cell.

Aspect 19: The method of any of Aspects 1-16, wherein measuring the signal transmitted from the candidate cell based on whether the candidate cell is an intra-frequency candidate cell or an inter-frequency candidate cell comprises measuring the signal from an intra-frequency candidate cell outside of an active BWP of the current serving cell with a fixed measurement gap.

Aspect 20: The method of any of Aspects 1-16, wherein measuring the signal transmitted from the candidate cell based on whether the candidate cell is an intra-frequency candidate cell or an inter-frequency candidate cell comprises measuring the signal from an intra-frequency candidate cell outside of an active BWP of the current serving cell with a measurement gap configured based on a reported capability of the UE and a receive timing difference between the current serving cell and the candidate cell.

Aspect 21: The method of any of Aspects 1-16, wherein measuring the signal transmitted from the candidate cell based on whether the candidate cell is an intra-frequency candidate cell or an inter-frequency candidate cell comprises determining a total gap based on a total or a maximum of a measurement gap for frequency tuning and a symbol gap for timing adjustment.

Aspect 22: A method of wireless communication at network node, comprising: transmitting, from a current serving cell, a configuration of a channel state information (CSI) reference signal (RS) measurement resource for layer 1 (L1) measurements of a candidate cell, wherein the configuration is based on whether the candidate cell is an intra-frequency candidate cell or an inter-frequency candidate cell; and receiving a L1 CSI report including measurements of the candidate cell.

Aspect 23: The method of Aspect 22, wherein the CSI-RS measurement resource for L1 measurements of an intra-frequency candidate cell is configured in an active downlink bandwidth part (BWP) of the current serving cell, wherein at least one of a scrambling seed, aligned point A configuration, a sub-carrier spacing, a center frequency, or a system frame number (SFN) offset is different than the current serving cell.

Aspect 24: The method of Aspect 22, wherein the CSI-RS measurement resource for L1 measurements of an intra-frequency candidate cell has a same center frequency and a same sub-carrier spacing as a CSI-RS resource for the serving cell.

Aspect 25: The method of Aspect 24, wherein the CSI-RS measurement resource for L1 measurements of the intra-frequency candidate cell is in an active BWP of the current serving cell or has a same SFN offset as the current serving cell.

Aspect 26: The method of any of Aspects 22-25, wherein transmitting, from the current serving cell, the configuration of the CSI-RS measurement resource for L1 measurements of the candidate cell comprises transmitting a CSI-RS measurement configuration of the current serving cell, wherein the CSI-RS measurement resource for L1 measurements of the candidate cell is labelled with an additional physical cell identifier (PCI) index.

Aspect 27: The method of Aspect 26, wherein the additional PCI index is linked to a configuration of the candidate cell.

Aspect 28: The method of Aspect 27, wherein the configuration of the candidate cell indicates one or more of: alignment of SFN; an effective isotropic radiated power (EIRP) offset from the current serving cell; scrambling sequence; BWP setting of the candidate cell; whether the candidate cell is configured with a symbol level gap or SSB measurement timing configuration (SMTC); or an assumed receive timing difference between the candidate cell and the current serving cell.

Aspect 29: The method of Aspect 27 or 28, wherein the configuration of an inter-frequency candidate cell includes a reference frequency CSI-RS.

Aspect 30: The method of Aspect 29, wherein the configuration of the candidate cell indicates one or more of: a measurement gap configuration, a sub-carrier spacing, a power offset, an SFN alignment with the serving cell, or bandwidth part information.

Aspect 31: The method of any of Aspects 22-25, wherein transmitting, from the current serving cell, the configuration of the CSI-RS measurement resource for L1 measurements of the candidate cell comprises transmitting a candidate cell configuration including the configuration of the CSI-RS measurement resource for L1 measurements of the candidate cell.

Aspect 32: The method of Aspect 31, wherein a radio resource control (RRC) configuration includes a reference signal configuration corresponding to a synchronization signal block (SSB) or a CSI-RS configured for mobility.

Aspect 33: The method of Aspect 32, wherein the reference signal configuration corresponding to the SSB includes a set of SSBs to be measured.

Aspect 34: The method of Aspect 32 or 33, wherein the reference signal configuration corresponding to the SSB of an inter-frequency candidate cell includes an SSB frequency, an SSB sub-carrier spacing, and a SMTC.

Aspect 35: The method of Aspect 34, wherein the reference signal configuration corresponding to the SSB of the inter-frequency candidate cell further includes an associated measurement gap configuration.

Aspect 36: The method of Aspect 32, wherein the reference signal configuration corresponding to a CSI-RS includes a reference cell index identifying a reference cell for timing.

Aspect 37: The method of Aspect 32, wherein the reference signal configuration corresponding to a CSI-RS includes one or more of: a sub-carrier spacing, a power offset, an SFN alignment with the serving cell, or bandwidth part information.

Aspect 38: An apparatus for wireless communication, comprising: one or more memories, individually or in combination, storing computer-executable instructions; and one or more processors coupled with the one or more memories and, individually or in combination, configured to: execute the computer-executable instructions to execute the instructions to perform the method of any of Aspects 1-21.

Aspect 39: An apparatus for wireless communication, comprising: one or more memories, individually or in combination, storing computer-executable instructions; and one or more processors coupled with the one or more memories and, individually or in combination, configured to execute the computer-executable instructions to perform the method of any of Aspects 22-37.

Aspect 40: An apparatus for wireless communication, comprising means for performing the method of any of Aspects 1-21.

Aspect 41: An apparatus for wireless communication, comprising means for performing the method of any of Aspects 22-37.

Aspect 42: A non-transitory computer-readable medium storing computer-executable instructions that when executed by a processor of a user equipment (UE) cause the UE to perform the method of any of Aspects 1-21.

Aspect 43: A non-transitory computer-readable medium storing computer-executable instructions that when executed by a processor of a network entity cause the network entity to perform the method of any of Aspects 22-37.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of wireless communication at a user equipment (UE), comprising:
receiving, from a current serving cell, a configuration of a channel state information reference signal (CSI-RS) measurement resource for layer 1 (L1) measurements of a candidate cell; and
measuring a signal transmitted from the candidate cell based on whether the candidate cell is an intra-frequency candidate cell or an inter-frequency candidate cell.

2. The method of claim 1, wherein the CSI-RS measurement resource for L1 measurements of an intra-frequency candidate cell is configured in an active downlink bandwidth part (BWP) of the current serving cell, wherein at least one of a scrambling seed, aligned point A configuration, a sub-carrier spacing, a center frequency, or a system frame number (SFN) offset is different than the current serving cell.

3. The method of claim 1, wherein the CSI-RS measurement resource for L1 measurements of an intra-frequency candidate cell has a same center frequency and a same sub-carrier spacing as a CSI-RS resource for the serving cell.

4. The method of claim 3, wherein the CSI-RS measurement resource for L1 measurements of the intra-frequency candidate cell is in an active BWP of the current serving cell or has a same SFN offset as the current serving cell.

5. The method of claim 1, wherein receiving, from the current serving cell, the configuration of the CSI-RS measurement resource for L1 measurements of the candidate cell comprises receiving a CSI-RS measurement configuration of the current serving cell, wherein the CSI-RS measurement resource for L1 measurements of the candidate cell is labelled with an additional physical cell identifier (PCI) index.

6. The method of claim 5, wherein the additional PCI index is linked to a configuration of the candidate cell.

7. The method of claim 6, wherein the configuration of the candidate cell indicates one or more of:
alignment of SFN;
an effective isotropic radiated power (EIRP) offset from the current serving cell;
scrambling sequence;
BWP setting of the candidate cell;
whether the candidate cell is configured with a symbol level gap or SSB measurement timing configuration (SMTC); or
an assumed receive timing difference between the candidate cell and the current serving cell.

8. The method of claim 6, wherein the configuration of an inter-frequency candidate cell includes a reference frequency CSI-RS.

9. The method of claim 8, wherein the configuration of the candidate cell indicates one or more of: a measurement gap configuration, a sub-carrier spacing, a power offset, an SFN alignment with the serving cell, or bandwidth part information.

10. The method of claim 1, wherein receiving, from the current serving cell, the configuration of the CSI-RS measurement resource for L1 measurements of the candidate cell comprises receiving a candidate cell configuration including the configuration of the CSI-RS measurement resource for L1 measurements of the candidate cell.

11. The method of claim 10, wherein a radio resource control (RRC) configuration includes a reference signal configuration corresponding to a synchronization signal block (SSB) or a CSI-RS configured for mobility.

12. The method of claim 11, wherein the reference signal configuration corresponding to the SSB includes a set of SSBs to be measured.

13. The method of claim 11, wherein the reference signal configuration corresponding to the SSB of an inter-frequency candidate cell includes an SSB frequency, an SSB sub-carrier spacing, and a SMTC.

14. The method of claim 13, wherein the reference signal configuration corresponding to the SSB of the inter-frequency candidate cell further includes an associated measurement gap configuration.

15. The method of claim 11, wherein the reference signal configuration corresponding to a CSI-RS includes a reference cell index identifying a reference cell for timing.

16. The method of claim 11, wherein the reference signal configuration corresponding to a CSI-RS includes one or more of: a sub-carrier spacing, a power offset, an SFN alignment with the serving cell, or bandwidth part information.

17. The method of claim 1, wherein measuring the signal transmitted from the candidate cell based on whether the candidate cell is an intra-frequency candidate cell or an inter-frequency candidate cell comprises measuring the signal from an intra-frequency candidate cell within an active BWP of the current serving cell without a measurement gap when a receive timing difference between the intra-frequency candidate cell and the current serving cell is less than a cyclic prefix length for an SCS of the intra-frequency candidate cell.

18. The method of claim 1, wherein measuring the signal transmitted from the candidate cell based on whether the candidate cell is an intra-frequency candidate cell or an inter-frequency candidate cell comprises measuring the signal from an intra-frequency candidate cell within an active BWP of the current serving cell with a symbol gap for receive timing adjustment when a receive timing difference between the intra- frequency candidate cell and the current serving cell is greater than a cyclic prefix length for an SCS of the intra-frequency candidate cell.

19. The method of claim 1, wherein measuring the signal transmitted from the candidate cell based on whether the candidate cell is an intra-frequency candidate cell or an inter-frequency candidate cell comprises measuring the signal from an intra-frequency candidate cell outside of an active BWP of the current serving cell with a fixed measurement gap.

20. The method of claim 1, wherein measuring the signal transmitted from the candidate cell based on whether the candidate cell is an intra-frequency candidate cell or an inter-frequency candidate cell comprises measuring the signal from an intra-frequency candidate cell outside of an active BWP of the current serving cell with a measurement gap configured based on a reported capability of the UE and a receive timing difference between the current serving cell and the candidate cell.

21. The method of claim 1, wherein measuring a signal transmitted from the candidate cell based on whether the candidate cell is an intra-frequency candidate cell or an inter-frequency candidate cell comprises determining a total gap based on a total or a maximum of a measurement gap for frequency tuning and a symbol gap for timing adjustment. 22 A method of wireless communication at network node, comprising:
transmitting, from a current serving cell, a configuration of a channel state information reference signal (CSI-RS) measurement resource for layer 1 (L1) measurements of a candidate cell, wherein the configuration is based on whether the candidate cell is an intra-frequency candidate cell or an inter-frequency candidate cell; and
receiving a L1 CSI report including measurements of the candidate cell.

23. The method of claim 22, wherein the CSI-RS measurement resource for L1 measurements of an intra-frequency candidate cell is configured in an active downlink bandwidth part (BWP) of the current serving cell, wherein at least one of a scrambling seed, aligned point A configuration, a sub-carrier spacing, a center frequency, or a system frame number (SFN) offset is different than the current serving cell.

24. The method of claim 22, wherein the CSI-RS measurement resource for L1 measurements of an intra-frequency candidate cell has a same center frequency and a same sub-carrier spacing as a CSI-RS resource for the serving cell.

25. The method of claim 24, wherein the CSI-RS measurement resource for L1 measurements of the intra-frequency candidate cell is in an active BWP of the current serving cell or has a same SFN offset as the current serving cell.

26. The method of claim 22, wherein transmitting, from the current serving cell, the configuration of the CSI-RS measurement resource for L1 measurements of the candidate cell comprises transmitting a CSI-RS measurement configuration of the current serving cell, wherein the CSI-RS measurement resource for L1 measurements of the candidate cell is labelled with an additional physical cell identifier (PCI) index.

27. The method of claim 26, wherein the additional PCI index is linked to a configuration of the candidate cell.

28. The method of claim 27, wherein the configuration of the candidate cell indicates one or more of:
alignment of SFN;
an effective isotropic radiated power (EIRP) offset from the current serving cell;
scrambling sequence;
BWP setting of the candidate cell;
whether the candidate cell is configured with a symbol level gap or SSB measurement timing configuration (SMTC); or
an assumed receive timing difference between the candidate cell and the current serving cell.

29. The method of claim 27, wherein the configuration of an inter-frequency candidate cell includes a reference frequency CSI-RS.

30. The method of claim 29, wherein the configuration of the candidate cell indicates one or more of: a measurement gap configuration, a sub-carrier spacing, a power offset, an SFN alignment with the serving cell, or bandwidth part information.

31. The method of claim 22, wherein transmitting, from the current serving cell, the configuration of the CSI-RS measurement resource for L1 measurements of the candidate cell comprises transmitting a candidate cell configuration including the configuration of the CSI-RS measurement resource for L1 measurements of the candidate cell.

32. The method of claim 31, wherein a radio resource control (RRC) configuration includes a reference signal configuration corresponding to a synchronization signal block (SSB) or a CSI-RS configured for mobility.

33. The method of claim 32, wherein the reference signal configuration corresponding to the SSB includes a set of SSBs to be measured.

34. The method of claim 32, wherein the reference signal configuration corresponding to the SSB of an inter-frequency candidate cell includes an SSB frequency, an SSB sub-carrier spacing, and a SMTC.

35. The method of claim 34, wherein the reference signal configuration corresponding to the SSB of the inter-frequency candidate cell further includes an associated measurement gap configuration.

36. The method of claim 32, wherein the reference signal configuration corresponding to a CSI-RS includes a reference cell index identifying a reference cell for timing.

37. The method of claim 32, wherein the reference signal configuration corresponding to a CSI-RS includes one or more of: a sub-carrier spacing, a power offset, an SFN alignment with the serving cell, or bandwidth part information.

38. An apparatus for wireless communication at a user equipment (UE), comprising:
one or more memories, individually or in combination, storing computer-executable instructions; and
one or more processors, coupled with the one or more memories and, individually or in combination, configured to: execute the computer-executable instructions to execute the instructions to:
receive, from a current serving cell, a configuration of a channel state information reference signal (CSI-RS) measurement resource for layer 1 (L1) measurements of a candidate cell; and
measure a signal transmitted from the candidate cell based on whether the candidate cell is an intra-frequency candidate cell or an inter-frequency candidate cell.

39. The apparatus of claim 38, wherein the CSI-RS measurement resource for L1 measurements of an intra-frequency candidate cell is configured in an active downlink bandwidth part (BWP) of the current serving cell, wherein at least one of a scrambling seed, aligned point A configuration, a sub-carrier spacing, a center frequency, or a system frame number (SFN) offset is different than the current serving cell.

40. The apparatus of claim 38, wherein the CSI-RS measurement resource for L1 measurements of an intra-frequency candidate cell has a same center frequency and a same sub-carrier spacing as a CSI-RS resource for the serving cell.

41. The apparatus of claim 40, wherein the CSI-RS measurement resource for L1 measurements of the intra-frequency candidate cell is in an active BWP of the current serving cell or has a same SFN offset as the current serving cell.

42. The apparatus of claim 38, wherein to receive, from the current serving cell, the configuration of the CSI-RS measurement resource for L1 measurements of the candidate cell, the one or more processors, individually or in combination, are configured to receive a CSI-RS measurement configuration of the current serving cell, wherein the CSI-RS measurement resource for L1 measurements of the candidate cell is labelled with an additional physical cell identifier (PCI) index.

43. The apparatus of claim 42, wherein the additional PCI index is linked to a configuration of the candidate cell.

44. The apparatus of claim 43, wherein the configuration of the candidate cell indicates one or more of:
alignment of SFN;
an effective isotropic radiated power (EIRP) offset from the current serving cell;
scrambling sequence;
BWP setting of the candidate cell;
whether the candidate cell is configured with a symbol level gap or SSB measurement timing configuration (SMTC); or
an assumed receive timing difference between the candidate cell and the current serving cell.

45. The apparatus of claim 43, wherein the configuration of an inter-frequency candidate cell includes a reference frequency CSI-RS.

46. The apparatus of claim 45, wherein the configuration of the candidate cell indicates one or more of: a measurement gap configuration, a sub-carrier spacing, a power offset, an SFN alignment with the serving cell, or bandwidth part information.

47. The apparatus of claim 38, to receive, from the current serving cell, the configuration of the CSI-RS measurement resource for L1 measurements of the candidate cell, the one or more processors, individually or in combination, are configured to receive a candidate cell configuration including the configuration of the CSI-RS measurement resource for L1 measurements of the candidate cell.

48. The apparatus of claim 47, wherein a radio resource control (RRC) configuration includes a reference signal configuration corresponding to a synchronization signal block (SSB) or a CSI-RS configured for mobility.

49. The apparatus of claim 48, wherein the reference signal configuration corresponding to the SSB includes a set of SSBs to be measured.

50. The apparatus of claim 48, wherein the reference signal configuration corresponding to the SSB of an inter-frequency candidate cell includes an SSB frequency, an SSB sub-carrier spacing, and a SMTC.

51. The apparatus of claim 50, wherein the reference signal configuration corresponding to the SSB of the inter-frequency candidate cell further includes an associated measurement gap configuration.

52. The apparatus of claim 48, wherein the reference signal configuration corresponding to a CSI-RS includes a reference cell index identifying a reference cell for timing.

53. The apparatus of claim 48, wherein the reference signal configuration corresponding to a CSI-RS includes one or more of: a sub-carrier spacing, a power offset, an SFN alignment with the serving cell, or bandwidth part information.

54. The apparatus of claim 38, wherein to measure the signal transmitted from the candidate cell based on whether the candidate cell is an intra-frequency candidate cell or an inter-frequency candidate cell, the one or more processors, individually or in combination, are configured to measure the signal from an intra-frequency candidate cell within an active BWP of the current serving cell without a measurement gap when a receive timing difference between the intra-frequency candidate cell and the current serving cell is less than a cyclic prefix length for an SCS of the intra-frequency candidate cell.

55. The apparatus of claim 38, , wherein to measure the signal transmitted from the candidate cell based on whether the candidate cell is an intra-frequency candidate cell or an inter-frequency candidate cell, the one or more processors, individually or in combination, are configured to measure the signal from an intra-frequency candidate cell within an active BWP of the current serving cell with a symbol gap for receive timing adjustment when a receive timing difference between the intra-frequency candidate cell and the current serving cell is greater than a cyclic prefix length for an SCS of the intra-frequency candidate cell.

56. The apparatus of claim 38, , wherein to measure the signal transmitted from the candidate cell based on whether the candidate cell is an intra-frequency candidate cell or an inter-frequency candidate cell, the one or more processors, individually or in combination, are configured to measure the signal from an intra-frequency candidate cell outside of an active BWP of the current serving cell with a fixed measurement gap.

57. The apparatus of claim 38, wherein to measure the signal transmitted from the candidate cell based on whether the candidate cell is an intra-frequency candidate cell or an inter-frequency candidate cell, the one or more processors, individually or in combination, are configured to measure the signal from an intra-frequency candidate cell outside of an active BWP of the current serving cell with a measurement gap configured based on a reported capability of the UE and a receive timing difference between the current serving cell and the candidate cell. 58 The apparatus of claim 38, , wherein to measure the signal transmitted from the candidate cell based on whether the candidate cell is an intra-frequency candidate cell or an inter-frequency candidate cell, the one or more processors, individually or in combination, are configured to measure determining a total gap based on a total or a maximum of a measurement gap for frequency tuning and a symbol gap for timing adjustment. 59 An apparatus for wireless communication at a user equipment (UE), comprising:
one or more memories, individually or in combination, storing computer-executable instructions; and
one or more processors, coupled with the one or more memories and, individually or in combination, configured to: execute the computer-executable instructions to execute the instructions to:
transmit, from a current serving cell, a configuration of a channel state information reference signal (CSI-RS) measurement resource for layer 1 (L1) measurements of a candidate cell, wherein the configuration is based on whether the candidate cell is an intra-frequency candidate cell or an inter-frequency candidate cell; and
receive a L1 CSI report including measurements of the candidate cell.

60. The apparatus of claim 59, wherein the CSI-RS measurement resource for L1 measurements of an intra-frequency candidate cell is configured in an active downlink bandwidth part (BWP) of the current serving cell, wherein at least one of a scrambling seed, aligned point A configuration, a sub-carrier spacing, a center frequency, or a system frame number (SFN) offset is different than the current serving cell.

61. The apparatus of claim 60, wherein the CSI-RS resource for L1 measurements of an intra-frequency candidate cell has a same center frequency and a same sub-carrier spacing as a CSI-RS resource for the serving cell.

62. The apparatus of claim 61, wherein the CSI-RS resource for L1 measurements of the intra-frequency candidate cell is in an active BWP of the current serving cell or has a same SFN offset as the current serving cell.

63. The apparatus of claim 59, wherein to transmit, from the current serving cell, the configuration of the CSI-RS measurement resource for L1 measurements of the candidate cell, the one or more processors, individually or in combination, are configured to transmit a CSI-RS measurement configuration of the current serving cell, wherein the CSI-RS measurement resource for L1 measurements of the candidate cell is labelled with an additional physical cell identifier (PCI) index.

64. The apparatus of claim 63, wherein the additional PCI index is linked to a configuration of the candidate cell.

65. The apparatus of claim 64, wherein the configuration of the candidate cell indicates one or more of:
alignment of SFN;
an effective isotropic radiated power (EIRP) offset from the current serving cell;
scrambling sequence;
BWP setting of the candidate cell;
whether the candidate cell is configured with a symbol level gap or SSB measurement timing configuration (SMTC); or
an assumed receive timing difference between the candidate cell and the current serving cell.

66. The apparatus of claim 64, wherein the configuration of an inter-frequency candidate cell includes a reference frequency CSI-RS.

67. The apparatus of claim 66, wherein the configuration of the candidate cell indicates one or more of: a measurement gap configuration, a sub-carrier spacing, a power offset, an SFN alignment with the serving cell, or bandwidth part information.

68. The apparatus of claim 59, wherein to transmit, from the current serving cell, the configuration of the CSI-RS measurement resource for L1 measurements of the candidate cell, the one or more processors, individually or in combination, are configured to transmit a candidate cell configuration including the configuration of the CSI-RS measurement resource for L1 measurements of the candidate cell.

69. The apparatus of claim 68, wherein a radio resource control (RRC) configuration includes a reference signal configuration corresponding to a synchronization signal block (SSB) or a CSI-RS configured for mobility.

70. The apparatus of claim 69, wherein the reference signal configuration corresponding to the SSB includes a set of SSBs to be measured.

71. The apparatus of claim 69, wherein the reference signal configuration corresponding to the SSB of an inter-frequency candidate cell includes an SSB frequency, an SSB sub-carrier spacing, and a SMTC.

72. The apparatus of claim 71, wherein the reference signal configuration corresponding to the SSB of the inter-frequency candidate cell further includes an associated measurement gap configuration.

73. The apparatus of claim 69, wherein the reference signal configuration corresponding to a CSI-RS includes a reference cell index identifying a reference cell for timing.

74. The apparatus of claim 69, wherein the reference signal configuration corresponding to a CSI-RS includes one or more of: a sub-carrier spacing, a power offset, an SFN alignment with the serving cell, or bandwidth part information.
